(19) United States
(12) Patent Application Publication
(10) Pub. No.: US 2009/0284574 A1
(43) Pub. Date: Nov. 19, 2009

(54) INK-JET RECORDING APPARATUS

(76) Inventor: Yukihiro Niekawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/305,625

(22) PCT Filed: May 24, 2007
(86) PCT No.: PCT/JP2007/060598

§ 371 Date: Dec. 18, 2008

(30) Foreign Application Priority Data
Jun. 23, 2006 (JP) 2006-173689

(51) Int. Cl. B41J 2/01

(52) U.S. Cl. 347/102

(57) ABSTRACT

An ink jet recording device has a recording head equipped with a nozzle for ejecting photocuring ink to a recording medium and also has light irradiation devices equipped with light sources for irradiating the photocuring ink deposited on the recording medium with light. The light irradiation devices can apply light to each block region in irradiation region on the recording medium divided into block regions and can bring the divided block region into an irradiation state or a non-irradiation state on a region by region basis. Further, in recording operation, on and off of the light sources are switched over by time sharing such that at least one of the block regions is in the non-irradiation state.

### FIELD OF THE INVENTION

The present invention relates to an ink-jet recording apparatus, particularly to an ink-jet recording apparatus equipped with a light irradiation device for irradiating a photocurable ink with light.

### BACKGROUND OF THE INVENTION

One of the conventionally known apparatuses for recording an image on such a recording medium as paper is an ink-jet recording apparatus wherein a photocurable ink is emitted onto the surface of the recording medium and light is applied to the ink having been deposited, so that the ink is cured. Such an ink-jet recording apparatus normally includes a recording head equipped with a plurality of nozzles for emitting ink to the recording medium, and a light irradiation device for irradiating the ink deposited on the surface of the recording medium.

The light source emitting the light of a wavelength capable of curing the ink is utilized as the light source of the light irradiation device. For example, a high-pressure mercury lamp, metal halide lamp, black light and cold-cathode tube have been employed in many cases in the conventional art.

However, such a discharge lamp involves such problems as fluctuations in the light illumination distribution, increased temperature, prolonged time to ensure stable emission of light, and reduced service life by repeated on and off operations. Various forms of ink-jet recording apparatuses have been proposed, as exemplified by the ink-jet recording apparatus wherein the LED (Light-Emitting Diode) characterized by reduced number of such problems is used as a light source (e.g., Patent Documents 1 through 7).

The light-emitting diode is generally characterized by compact configuration, light weight and superb responsiveness. When used in the ink-jet recording apparatus, the light-emitting diode provides compact configuration and light weight, and is expected to reduce the time for warming up operation.

Patent Document 1: Japanese Unexamined Patent Application Publication No. 2004-181943

Patent Document 2: Japanese Unexamined Patent Application Publication No. 2004-237588

Patent Document 3: Japanese Unexamined Patent Application Publication No. 2005-104108

Patent Document 4: Japanese Unexamined Patent Application Publication No. 2005-144679

Patent Document 5: Japanese Unexamined Patent Application Publication No. 2005-254560

Patent Document 6: Japanese Unexamined Patent Application Publication No. 2006-27235

Patent Document 7: Japanese Unexamined Patent Application Publication No. 2006-27236

### DISCLOSURE OF INVENTION

### Problems to be Solved by the Invention

However, the current light-emitting diode is not always characterized by reduced power consumption.

To cure the photocurable ink, a large current is required to irradiate the comparatively large area on the recording medium by using a light-emitting diode at a high intensity of illumination. This requires use of a power supply having a large maximum current value. Further, the cabling route connecting the power supply with the light irradiation device is required to have a large diameter. This cannot be said to provide high power transmission efficiency.

Further, the current light-emitting diode has a comparatively large heat value. As shown in FIG. 7, a larger fin 101 for a heat sink, a larger fan 102 and a motor 103 for air cooling must be mounted on the back surface of a thin light-emitting diode 100. Alternatively, installation of a water-cooling mechanism is required.

As described above, in the present situation, when a light-emitting diode is used as a light source, a large power source and thick cabling are required, and a larger heat sink and motor must be installed on the rear surface. In some cases, a water-cooling mechanism must be installed. Thus, use of the light-emitting diode does not always ensure a compact configuration or light weight of the light irradiation device and carriage, as may be expected.

Thus, the object of the present invention is to provide an ink-jet recording apparatus capable of suppressing the electric current consumed by the light irradiation device or the heat generation, and ensuring a compact configuration or light weight of the light irradiation device and carriage.

### Means for Solving the Problems

To solve the aforementioned problems, the ink-jet recording apparatus described in Claim 1 includes:

a recording head equipped with a nozzle for emitting photocurable ink to a recording medium; and

a light irradiation device equipped with a light source for irradiating the photocurable ink placed on the recording medium;

wherein the light irradiation device is capable of irradiating each of the block regions of the irradiation region on the recording medium divided into a plurality of block regions, is capable of selecting between the irradiation state and non-irradiation state for each of the divided block regions, and switches the on and off state of the light source according to time-sharing basis to ensure that at least one of a plurality of the aforementioned block regions is set to the non-irradiation state during the recording operation.

According to the invention of Claim 1, in the ink-jet recording apparatus, the ink emitted from the nozzle of the recording head is irradiated by the light irradiation device. The irradiation region on the recording medium irradiated by the light irradiation device is divided into a plurality of block regions. The light irradiation device is capable of selecting either an irradiation state or a non-irradiation state for each of the divided block regions. During the recording operation, the on and off state of the light irradiation device is switched on a time-sharing basis to ensure that at least one of a plurality of block regions in the irradiation region will be placed in the non-irradiation state.

The invention according to Claim 2 is the ink-jet recording apparatus described in Claim 1 further characterized in that the light source of the light irradiation device is made of a semiconductor light source.

According to the invention of Claim 2, irradiation is provided by the light irradiation device having the light source made of the semiconductor light source such as a light-emitting diode.

The invention according to Claim 3 is the ink-jet recording apparatus described in Claim 1 or 2 further characterized in that switching operation on the time-sharing basis is performed with reference to pixel clocks.

According to the invention of Claim 3, a pixel clock is formed according to the value of the scale while the scanning position of the recording head is checked, for example, by a linear encoder, and the switching of the on and off state is performed on the time-sharing basis with reference to the pixel clock.

The invention according to Claim 4 is the ink-jet recording apparatus described in any one of Claims 1 through 3 further characterized in that, in the light irradiation device, at the time of thinned-out recording, while the block region of the irradiation region passes through the thinned-out pixel position, for this block region, the non-irradiation state is set.

According to the invention of Claim 4, the ink-jet recording apparatus is structured in such a way that, when the so-called thinned-out recording wherein recording is performed by omitting every other pixel, the light source of the light irradiation device is not turned on while the block region of the irradiation region which moves with the scanning of the recording head passes through the pixel position without ink included therein. For this block region, the non-irradiation state is set.

The invention according to Claim 5 is the ink-jet recording apparatus described in any one of Claims 1 through 4 further characterized in that the light irradiation device is capable of irradiating each block region of the irradiation region on the recording medium, which is divided into regions each of which is equivalent to the recording width of the recording head.

According to the invention of Claim 5, when one recording head is formed by arrangement of a plurality of nozzle rows and ink is emitted from the nozzles of each nozzle row in separate emission timing, the irradiation region having the width equivalent to the recording width of the recording head is divided into block regions whose number is equivalent to the number of nozzle rows and each block region is separately irradiated by the light irradiation device.

The invention according to Claim 6 is the ink-jet recording apparatus described in any one of Claims 1 through 4 further characterized in that the nozzles of the recording head are divided into a plurality of groups, and the light irradiation device is capable of irradiating each block region of the irradiation region on the recording medium, which is divided into regions on each of which the photocurable ink is emitted from the nozzles in each group of the recording head.

According to the invention of Claim 6, when one row of nozzles of one recording head is divided into several groups and ink is emitted from each in separate timing, the light irradiation device irradiates each block region of the irradiation region on the recording medium, divided so as to conform to the nozzles of each group.

The invention according to Claim 7 is the ink-jet recording apparatus described in Claim 6 further characterized in that:

the recording head is a multi-phase drive type head;

each group of the recording head is driven according to each phase of multi-phase drive; and

switching on the time-sharing basis is performed according to phase of multi-phase drive.

According to the invention of Claim 7, in the ink-jet recording apparatus described in Cclaim 6, the nozzles of each group of the recording head are driven according to each phase of the multi-phase drive whereby ink is emitted, and the on and off switching operation of the light irradiation device is performed according to the phase synchronized therewith.

The invention according to Claim 8 is the ink-jet recording apparatus described in any one of Claims 1 through 7 further characterized in that the light sources of the light irradiation device are installed in staggered arrangement, and each light source is turned on separately according to each phase.

According to the invention of Claim 8, the light irradiation device irradiates the ink emitted on the recording medium wherein the light sources are installed in staggered arrangement, and are formed in groups, so that each group irradiates separately according to each phase.

The invention according to Claim 9 is the ink-jet recording apparatus described in any one of Claims 1 through 8 further characterized in that the light source of the light irradiation device is structured in such a way that a plurality of light-emitting diodes are connected in series for each light source conforming to each block region of the irradiation region on the recording medium.

According to the invention of Claim 9, irradiation is provided by the light irradiation device wherein a plurality of light-emitting diodes are connected in series for each light source conforming to each block region of the irradiation region on the recording medium.

The invention according to Claim 10 is the ink-jet recording apparatus described in any one of Claims 1 through 8 further characterized in that the light source of the light irradiation device is structured to supply the alternating current to the circuit composed of at least two sets of light-emitting diodes wherein an anode and cathode are connected in a reverse direction, and that each block region of the irradiation region on the recording medium is divided for each direction of the light source connection.

According to the invention of Claim 10, the alternating current is supplied to the circuit composed of at least two sets of light-emitting diodes wherein an anode and cathode are connected in a reverse direction, and two sets of the light-emitting diodes are turned on alternately one by one, whereby irradiation is provided by the light irradiation device.

### EFFECTS OF THE INVENTION

According to the invention of Claim 1, at least one of the block regions of the irradiation region is set to the non-irradiation state during the recording operation. Accordingly, not all the irradiation regions are placed in the irradiation state simultaneously. This arrangement eliminates the case of lighting of all the light sources of the light irradiation device, and reduces the current to be consumed by the light irradiation device. The on and off state of the light irradiation device is repeated, whereby the heat value generated by the light irradiation device can be suppressed.

Accordingly, when the light-emitting diode, for example, is used as the light source, there is no need of installing a large heat sink, fan or motor as shown in FIG. 7. Alternatively, a smaller heat sink can be used. This arrangement provides a compact configuration and light weight of the light irradiation device as well as a compact configuration and light weight of the carriage for mounting the light irradiation device.

According to the invention of Claim 2, the semiconductor light source eliminates the problems found in the conventional discharge lamp, such as fluctuations in the light illumination distribution, increased temperature, prolonged time to ensure stable emission of light, and reduced service life by repeated on and off state which makes need of continuous lighting during a recording job. In addition to the advantages of the invention described in Claim 1, use of the semiconductor light source eliminates such problems, and provides a compact configuration and light weight of the light irradiation device and carriage

According to the invention of Claim 3, while the scanning position of the recording head is checked, for example, by a linear encoder, a pixel clock is formed from the scale value, the on and off state of the light source of the light irradiation device is switched on the time-sharing basis with reference to the pixel clock, whereby the light source of the light irradiation device can be turned on accurately above the ink emitted onto the recording medium and the block region of the irradiation region can be placed in the irradiation state. Thus, the advantages of the invention described in the aforementioned Claims are more adequately exhibited.

According to the invention of Claim 4, at the time of recording by thinning-out pixel, the light source of the light irradiation device is not turned on at the omitted pixel position where ink is not included and only pixel position where ink may be included is irradiated. This eliminates the case of turning on all the light sources of the light irradiation device, and suppresses the current value wasted in the light irradiation device, whereby the advantages of the invention according to the aforementioned Claims are more adequately exhibited.

According to the invention of Claim 5, even when one recording head is formed by arrangement of a plurality of nozzle rows, the invention described in the aforementioned Claims can also be applied. Thus, the advantages of the invention described in the aforementioned Claims are effectively exhibited.

According to the invention of Claim 6, even when the nozzles of one recording head are divided into a plurality of groups, and ink is emitted from the nozzles in separate emission timing, the invention described in the aforementioned Claims can also be applied. Thus, the advantages of the invention described in the aforementioned Claims are effectively exhibited.

According to the invention of Claim 7, in the ink-jet recording apparatus described in Claim 6, the nozzles of each group of the recording head are driven according to each phase of the multi-phase drive whereby ink is emitted, and the on and off switching operation of the light irradiation device is performed according to the phase synchronized therewith. This arrangement provides easy implementation of the ink-jet recording apparatus of Claim 6, and the advantages of the invention described in the aforementioned Claim 6 are easily and adequately exhibited.

According to the invention of Claim 8, the light sources are installed in staggered arrangement, and are formed in groups, which are divided into each group for each phase, whereby irradiation is provided on ink deposited on the recording medium by the light irradiation device. Therefore, the advantages of the aforementioned Claims are adequately exhibited in any type of the recording head, regardless of the arrangement and drive methods of the nozzles of the recording head, namely, independently of whether the nozzles of the recording head are installed in a straight arrangement, staggered arrangement or other arrangement, or whether the nozzles are driven in a single-phase or multi-phase mode.

According to the invention of Claim 9, the light sources of the light irradiation device are connected in series, whereby the current value supplied to the light source is reduced as compared to the case of parallel connection. Due to excellent transmission efficiency, the advantages of the invention described in the aforementioned Claim are effectively exhibited.

According to the invention of Claim 10, the alternating current is supplied to the circuit composed of at least two sets of light-emitting diodes wherein an anode and cathode are connected in a reverse direction, and two sets of the light-emitting diodes are turned on alternately one by one, whereby irradiation is provided by the light irradiation device. This arrangement reduces the amount of current supplies to the light sources since the light sources are connected in series in each set. The on and off state of the light source of the light irradiation device can be switched on the time-sharing basis using a simple circuit. Further, the amount of the wire connection can also be reduced, and the advantages of the invention described in the aforementioned Claim are adequately exhibited.

### BRIEF DESCRIPTION OF THE DRAWINGS

FIG. 1 is a drawing showing the structure of the ink-jet recording apparatus as a first embodiment.

FIG. 2 is a diagram representing the structure of the recording head and light irradiation device and each block region of the irradiation region as a first embodiment.

FIG. 3 is a diagram showing the structure of the recording head and light irradiation device and each block region of the irradiation region as a second embodiment.

FIG. 4(A) is a diagram showing the circuit configuration of light-emitting diode of the light irradiation device, and FIG. 4(B) is a diagram showing the alternating current supplied to the circuit.

FIG. 5 is a diagram showing the structure of the recording head and light irradiation device and each block region of the irradiation region as a third embodiment.

FIG. 6 is a diagram showing the structure of the light irradiation device and each block region of the irradiation region as a fourth embodiment.

FIG. 7 is a diagram showing a light-emitting diode and heat sink.

### DESCRIPTION OF REFERENCE NUMERALS

1 Ink-jet recording apparatus
5, 5Y, 5M, 5C, 5K Recording heads
6, 6a, 6b, 6R, 6R, 6a, 6β, 6γ Nozzles
7, 7a, 7b 7L, 7R, 7α, 7β, 7γ Light irradiation device
8a, 8b, 8L, 8R, 8α, 8β, 8γ Light source
I photocurable ink
P Recording medium
Ra, Rb, RL, RR, Rα, Rβ, Rγ Block regions of irradiation regions
α, β, γ Groups

### BEST MODE FOR CARRYING OUT THE INVENTION

The following describes the embodiments of the ink-jet recording apparatus of the present invention with reference to drawings:

### Embodiment 1

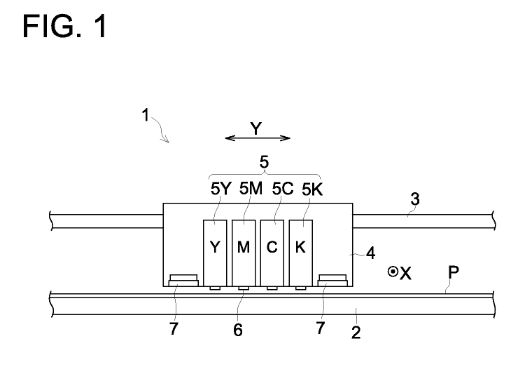

In the first embodiment, as shown in FIG. 1, the ink-jet recording apparatus 1 is provided with a flat platen 2 supporting the recording medium P. A plurality of conveyance rollers (not illustrated) for conveying the recording medium P are arranged on the upstream and downstream sides of the platen 2 in the traveling direction of the recording medium P, namely, on the upstream and downstream sides in the sub-scanning direction indicated by “X” in the drawing.

Above the platen 2, a rod-like carriage rail 3 is arranged parallel to the platen 2 and recording medium P and perpendicular to the sub-scanning direction. This carriage rail 3 supports an approximately cabinet-shaped carriage 4 which is capable of reciprocating motion along the carriage rail 3 in the main scanning direction indicated by “Y” in the drawing.

A recording head 5 is mounted on the bottom surface of the carriage 4′ and is provided with a plurality of nozzles 6 that emit a photocurable ink onto the recording medium P supported by the platen 2. The present embodiment is designed in such a way that the ink of one of the colors, yellow (Y), magenta (M), cyan (C) and black (K) is emitted from a plurality of nozzles included in one recording head 5, and a color image is formed on the recording medium P by the ink of different colors emitted from a plurality of recording head 5.

Each of the recording heads 5 is connected with ink tank for supplying each ink of Y, M, C and K through a supply pipe (not illustrated). A reading apparatus is fixed on the back surface of the carriage 4 to read the scale of the linear encoder arranged in parallel to the carriage rail 3. Thus, the scanning position of the carriage 4, namely, the scanning position of the recording head 5 or light irradiation device 7 (to be described later) is identified.

Light irradiation devices 7 equipped with a light source (not illustrated) for irradiating the ink deposited on the recording medium P are arranged on the upstream and downstream sides in the main scanning direction of the recording head 5 mounted on the carriage 4. In the present embodiment, a semiconductor light source is used as the light source of the light irradiation device 7. A light-emitting diode in particular is used.

In the present embodiment, one light irradiation device 7 is mounted on each of the upstream and downstream sides of the recording heads 5Y, 5 M, 5C and 5K in the main scanning direction, as shown in FIG. 1. However, a further light irradiation device 7 can be mounted, for example, between the recording heads.

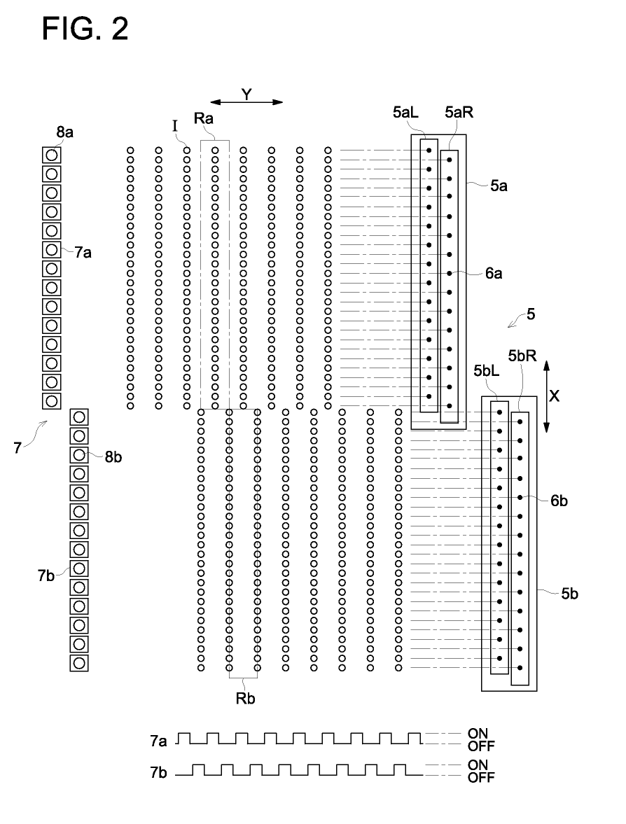

In the present invention, each recording head 5 is composed of two unit heads 5a and 5b arranged in the direction of nozzle row, as shown in FIG. 2. Further, the unit head 5a is made of two nozzle rows 5aL and 5aR laminated with each other. The nozzles 6a are installed on the nozzle rows 5aL and 5aR included in the unit head 5a for every other pixel, and two nozzle rows 5aL and 5aR are laminated, with each nozzle position displaced from each other by one pixel. The unit head 5b is structured in the same manner as the unit head 5a.

The nozzle 6a at the lowermost end in the drawing of the head unit 5a and the nozzle 6b at the uppermost end in the drawing of the head unit 5b are arranged so as to record the pixel portions adjacent to each other in the sub-scanning direction X on the recording medium.

In the present embodiment, when scanning of the recording head 5 is performed in the main scanning direction Y, ink I is emitted from each nozzle 6a of the unit head 5a so that ink I is arranged on the recording medium for every other pixel in the main scanning direction Y and in a straight line in the sub-scanning direction X. Similarly, the ink I is emitted from each nozzle 6b of the unit head 5b so that ink I is arranged on the recording medium for every other pixel in the main scanning direction Y, and in a straight line in the sub-scanning direction X. However, ink is emitted to the position displaced by one pixel in the main scanning direction Y, from a row of ink emitted from the unit head 5a.

In the present embodiment, so-called two-pass recording is carried out wherein the unit heads 5a and 5b each perform so-called thinned-out recording, and the image recording operation is completed as a whole. It should be noted, however, that the present invention is not restricted to the two-pass recording. The present invention is similarly applicable to the case of multi-pass recording wherein image recording is carried out in a greater number of passes.

In the present invention, the recording head 5 is divided into the unit heads 5a and 5b, and the light irradiation device 7 is divided into the light irradiation devices 7a and 7b according to the above division. The light irradiation devices 7a and 7b are placed in parallel to a row of ink so as to irradiate the ink I emitted onto the recording medium from the unit heads 5a and 5b of the recording head 5 respectively.

The light irradiation devices 7a and 7b are arranged in such a way that the mutual positions agree with each other in the main scanning direction Y or a displacement occurs in the main scanning direction Y by an even number of pixels such as two or four pixels. In the present embodiment, it is only required that the ink I emitted from the unit heads 5a and 5b of the recording head 5 can be irradiated by the light irradiation devices 7a and 7b respectively. It is not always required that there should be agreement between the number of nozzles on the unit heads 7a and 7b, and the number of the light sources 8a and 8b of the light irradiation device.

In the present invention, the region on the recording medium that can be irradiated by the light irradiation devices 7 is called the irradiation region. The irradiation region is normally the region on the recording medium opposed to the light irradiation device 7. In the present embodiment, as shown by the broken line of FIG. 2, the irradiation region is formed by the two regions Ra and Rb on the recording medium to be irradiated by the light irradiation devices 7a and 7b constituting the light irradiation devices 7. The irradiation regions Ra and Rb are moved in the main scanning direction Y on the recording medium by the scanning of the light irradiation devices 7a and 7b resulting from the reciprocating motion of the carriage 4 in the main scanning direction Y.

To be more specific, in the present invention, the irradiation region is divided into two block regions Ra and Rb, and control is provided in such a way that the on and off state of the light irradiation devices 7a and 7b is switched on the time-sharing basis for each of block regions Ra and Rb. The irradiation region is set to the irradiation state or non-irradiation state for each of the divided block regions.

To put it more specifically, the scale of the liner encoder read by the reading apparatus is converted into the pixel block shown by the bottom position of FIG. 2, by the controller (not illustrated) of the ink-jet recording apparatus 1. The on and off state of the light sources 8a and 8b of the light irradiation devices 7a and 7b is switched on the time-sharing basis according to this pixel clock. During the passage over the position of the pixel containing the row of ink deposited by the unit heads 5a and 5b of the recording head 5 by the method of thinning-out of pixels, the block region of the irradiation region is set to the irradiation state. During the passage over the position of the pixel containing no row of ink deposited by the method of thinning-out of pixel, the block region of the irradiation region is set to the non-irradiation state.

When the positions of the light irradiation devices 7a and 7b are formed to agree with each other in the main scanning direction Y, the aforementioned two regions Ra and Rb are connected with each other. Since the light irradiation devices 7a and 7b are controlled separately, the irradiation region is divided into two block regions Ra and Rb, which are separately placed in the irradiation state and non-irradiation state.

In this embodiment, the pixel clocks are created wherein the on and off state is reversed between the light irradiation devices 7a and 7b as shown on the bottom position. To be more specific, in this embodiment, the on and off state of the light sources 8a and 8b of the light irradiation devices 7a and 7b is switched on the time-sharing basis according to the pixel clock, so that during the recording operation, one of the two block regions Ra and Rb of the irradiation region is put into the irradiation state, the other block region is placed in the non-irradiation state.

In this embodiment, in a plurality of light-emitting diodes constituting the light source 8a of the light irradiation device 7a, the anode of each light-emitting diode is connected to the cathode of the other light-emitting diode. To be more specific, a plurality of light-emitting diodes are connected in series. The light source 8b of the light irradiation device 7b is also formed in the same manner.

The following describes the operations of the ink-jet recording apparatus 1 of the present invention.

When the recording start has been instructed, the controller (not illustrated) of the ink-jet recording apparatus 1 causes the reciprocating motion of the carriage 4 along the carriage rail 3, and allows the recording head 5 to scan on the recording medium in the main scanning direction Y. At the same time, while checking the scanning position of the recording head 5 according to the scale of the linear encoder read by the reading apparatus, the controller applies the drive voltage to the nozzles 6 of the recording head 5 in appropriate emission timing, and allows the photocurable ink to be emitted onto the recording medium.

The following describes the so-called solid print operation wherein ink is emitted from all nozzles at the time of emission. As shown in FIG. 2, while the recording head 5 moves in one direction of the main scanning direction Y, ink I is emitted from each of the nozzles 6a and 6b of the unit heads 5a and 5b of the recording head 5 in the method of recording by thinning out pixels, namely, so as to be arranged for every other pixel in the main scanning direction Y on the recording medium and in a straight line in the sub-scanning direction X.

In the light irradiation devices 7a and 7b corresponding to the unit heads 5a and 5b, the on and off state of the light sources 8a and 8b is switched by the controller on the time-sharing basis according to the pixel clock formed based on the scale of the linear encoder. In the present embodiment, control is provided according to the pixel clocks wherein the on and off state is reversed between the light irradiation devices 7a and 7b shown in the lowermost step of FIG. 2. Then, when the light irradiation device 7a is on, the light irradiation device 7b is off, and when the light irradiation device 7a is off, the light irradiation device 7b is on.

A row of ink is deposited on the recording medium by the unit heads 5a and 5b at the positions displaced from each other by one pixel in the main scanning direction Y. The light irradiation devices 7a and 7b are arranged so as to be displaced from each other by an even number of pixels. Therefore, when the light irradiation device 7a is located above the pixel position where a row of ink is included, the light irradiation device 7b is situated above the thinned-out pixel position where a row of ink is not contained. Conversely, when the light irradiation device 7a is situated above the thinned-out pixel position where the row of ink is not contained, the light irradiation device 7b is located at the above the pixel position where the row of ink is included.

During the passage of the light irradiation device 7a over the pixel position containing the row of ink, the light source 8a of the light irradiation device 7a is turned on in response to the pixel clock. The block region Ra of the irradiation region is set to the irradiation state and the ink emitted onto the recording medium is irradiated, whereby ink is cured. In this case, the light irradiation device 7b passes over the thinned-out pixel position without a row of ink contained therein. Accordingly, the light source 8a is turned off in response to the pixel clock, and the block region Rb of the irradiation region is set to the non-irradiation state.

When the light irradiation devices 7a and 7b move to the adjacent pixel positions in the main scanning direction Y respectively with the scanning of the carriage 4, the light source 8a of the light irradiation device 7a is turned off in response to the pixel clock and the block region Ra is set to the non-irradiation state. This is associated with the situation where the light irradiation device 7a passes over the thinned-out pixel position where a row of ink is not contained.

This movement allows the light irradiation device 7b to pass over the pixel position where the row of ink is included. The light source 8b is turned on in response to the pixel clock, and the block region Rb of the irradiation region is set to the irradiation state. Thus, the ink emitted on the recording medium is irradiated and is cured.

As described above, in the ink-jet recording apparatus 1 of the present embodiment, the on and off state of the light irradiation devices 7a and 7b is switched on the time-sharing basis during the recording operation, and two block regions Ra and Rb of the irradiation region on the recording medium are alternately placed in the irradiation state. Thus, at least one of the block regions of the irradiation region is set to the non-irradiation state.

As described above, in the present embodiment, not all the regions of the irradiation region are set to the irradiation state simultaneously, and not all the light sources of the light irradiation device are turned on. This arrangement saves the current consumed in the light irradiation device. Further, the light irradiation device repeats on and off operations. This arrangement reduces the amount of heat generated from the light irradiation device.

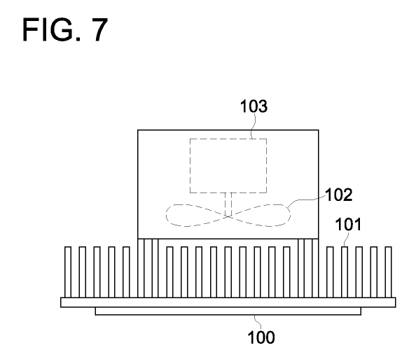

Thus, even when a light-emitting diode is used as the light source, there is no need of installing a large-sized heat sink, fan or motor as shown in FIG. 7, or a smaller heat sink and others can be used. This ensures compact configuration and reduced weight of the light irradiation device. This, in turn, ensures compact configuration and reduced weight of the carriage mounting them.

The light sources of the light irradiation device are connected in series. This connection reduces the current supplied to the light source and improves the transmission efficiency, as compared to the case of parallel connection. This provides more effective use of the aforementioned advantages.

The aforementioned description with reference to FIG. 2 refers to the so-called solid print operation wherein ink is emitted from all nozzles. Among the block regions of the irradiation region, the block region placed at the irradiation state has the ink emitted onto the recording medium without fail. In the normal image recording mode, however, ink is not always emitted onto the block region where the irradiation state is set. However, for the region where the ink is not emitted onto the recording medium, the block regions of the irradiation region are set to the non-irradiation state.

The aforementioned description of the present embodiment refers to the case wherein the recording head 5 is composed of two steps of unit heads 5a and 5b. Without being restricted thereto, the present invention is applicable to the cases wherein the recording head 5 is made up of more steps.

In the present embodiment, reference has been made to the case wherein ink is directly emitted from the recording head 5 to the recording medium P to perform recording, as shown in FIG. 1. Without being restricted thereto, the present invention is applicable to another ink-jet recording apparatus, for example, wherein ink is emitted from the recording head onto the intermediate medium such as a transfer drum, and ink is then transferred from the intermediate medium onto the recording medium.

### Embodiment 2

In the description of the first embodiment, reference has been made to the case wherein the recording head 5 is formed of the unit head 5a made up of the nozzle rows 5aL and 5aR laminated with each other, and the unit head 5b made up of the nozzle rows 5bL and 5bR laminated with each other. Ink is emitted from the unit heads 5a and 5b onto the same pixel position in the main scanning direction Y respectively, whereby a row of ink is formed on the recording medium.

The following describes the second embodiment, wherein inks are separately emitted from the nozzles of the nozzle rows of the unit head of the ink-jet recording apparatus respectively, and rows of ink arranged alternately in the main scanning direction Y are formed on the recording medium.

The following description of the present embodiment refers to the case wherein the recording head 5 is formed of one step. However, the present invention is applicable to each of the steps when the recording head 5 is formed of two steps of the unit heads 5a and 5b as in the case of the first embodiment, or a greater number of steps. The members having the same functions as those of the aforementioned first embodiment will not be described, or will be described with the same numerals of reference assigned therewith.

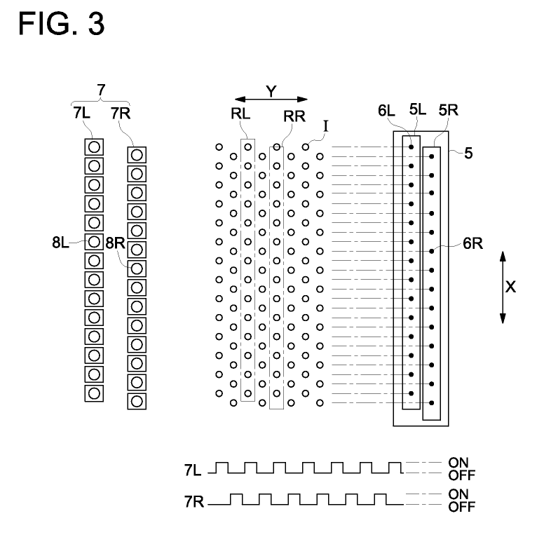

FIG. 1 shows the overall configuration of the ink-jet recording apparatus of the present embodiment. As shown in FIG. 3, the recording head 5 is made up of two nozzle rows 5L and 5R laminated with each other, similarly to the unit head 5a of the first embodiment. The nozzle rows 5L and 5R each are provided with nozzles 6L and 6R for every other pixel respectively. Two nozzle rows 5L and 5R are laminated with each other with the nozzle position being displaced from each other by one pixel.

At the time of scanning of the recording head 5 in the main scanning direction Y, ink I is emitted from the nozzle row 5L, and the rows of ink linearly deposited on the recording medium for every other pixel in the sub-scanning direction X are arranged for every other pixel in the main scanning direction Y. In the similar manner, ink I is emitted from the nozzle row 5R, and the row of ink linearly deposited on the recording medium for every other pixel in the sub-scanning direction X are arranged for every other pixel in the main scanning direction Y. Ink is emitted at the position displaced from the row of ink emitted from the nozzle row 5L, by one pixel each in the main scanning direction Y and in the sub-scanning direction X.

In this embodiment, the reverse movement of the recording head 5 in the main scanning direction Y causes the ink to be emitted to the pixel position where the ink I on the recording medium has not been emitted. The reciprocating motion of the recording head 5 in the main scanning direction Y, namely, the image recording operation is completed in two passes. It should be noted, however, that the present invention is not restricted to two-pass recording. The present invention is similarly applicable to the case of multi-pass recording wherein image recording is carried out in a greater number of passes.

In the present embodiment, the light irradiation device 7 is divided into the light irradiation devices 7L and 7R in conformity to the nozzle rows unit head 5L and 5R of the recording head 5. The light irradiation devices 7L and 7R are arranged parallel to the row of ink so as to irradiate the ink I having been emitted on the recording medium from the nozzle rows 5L and 5R of the recording head 5

The light irradiation devices 7L and 7R are arranged so as to be displaced from each other in the main scanning direction Y by an even number of pixels such as two or four pixels. In the present embodiment also, it is only required that the light irradiation devices 7L and 7R are capable of irradiating the ink I emitted by the nozzle rows 5L and 5R of the recording head 5. The number of the nozzles of the nozzle rows 5L and 5R is not necessarily been required to agree with the number of the light sources 8L and 8R of the light irradiation device.

In the present embodiment, the irradiation region on the recording medium that can be irradiated by the light irradiation device 7 is made up of two regions RL and RR on the recording medium irradiated by the light irradiation devices 7L and 7R, as shown by the broken line of FIG. 3. To be more specific, in the present embodiment, the light irradiation devices 7L and 7R are capable of irradiating the block regions RL and RR in the irradiation region on the recording medium divided into areas each corresponding to the recording width of the nozzle row 5L or 5R of the recording head 5. The irradiation regions RL and RR are moved on the recording medium in the main scanning direction Y by the scanning of the light irradiation devices 7L and 7R resulting from the reciprocating motion of the carriage 4 in the main scanning direction Y.

To be more specific, in the present embodiment, the irradiation region is divided into two block regions RL and RR. Control is provided in such a way that the on and off state of the light irradiation devices 7L and 7R can be switched on the time-sharing basis for each of block regions RL and RR. The irradiation region is set to the irradiation state or non-irradiation state for each divided block region.

In this embodiment, similarly to the case of the first embodiment, it is also possible to arrange such a configuration that a plurality of light-emitting diodes constituting the light sources 8L and 8R of the light irradiation devices 7L and 7R are independently connected in series, and the on and off state of the light sources 8L and 8R of the light irradiation devices 7L and 7R is switched on the time-sharing basis with reference to the pixel block.

The following describes the present embodiment wherein a plurality of light-emitting diodes constituting the light sources 8L and 8R of the light irradiation devices 7L and 7R are integrated and alternating current is supplied to control the on and off state. The on and off state control by the alternating current in the present embodiment can be used in the first embodiment.

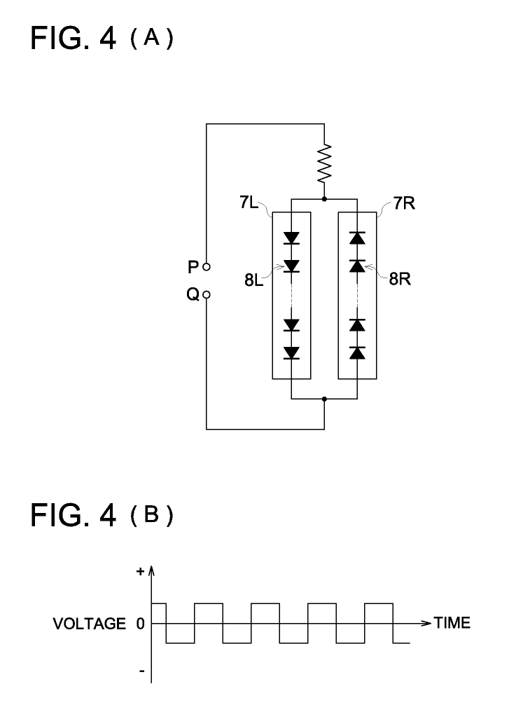

In the present embodiment, a plurality of light-emitting diodes constituting the light sources 8L and 8R of the light irradiation devices 7L and 7R have the circuit shown in FIG. 4 (A). To be more specific, in this circuit, each of a set of light-emitting diodes as the light source 8L of the light irradiation device 7L, and a set of light-emitting diodes as the light source 8R of the light irradiation device 7R is connected in series respectively. Connection direction of the anode and cathode is reversed for the light irradiation device 7L and light irradiation device 7R.

The alternating voltage having a rectangular waveform of a predetermined cycle shown in FIG. 4 (B) is applied to the terminals P and Q of the circuit, and alternating current is supplied to the circuit. In the cycle wherein current flows from the terminal P to the terminal Q, the light source 8L of the light irradiation device 7L is turned on and the light source 8R of the light irradiation device 7R is turned off. In the cycle wherein current flows from the terminal P to the terminal Q, the light source 8L of the light irradiation device 7L is turned off and the light source 8R of the light irradiation device 7R is turned on.

As described above, in the present embodiment, the light irradiation devices 7L and 7R are divided according to the direction in the connection of the light-emitting diodes as the light sources 8L and 8R. The block regions RL and RR of the irradiation region of FIG. 3 are also divided according to the direction in the connection of the light-emitting diodes as the light sources 8L and 8R.

The cycle of the rectangular waveform of FIG. 4 (B) is changed by the scanning speed of the carriage 4 calculated from the scale of the linear encoder read by the reading apparatus. Thus, when the light irradiation device 7L passes over the row of ink on the recording medium emitted from the nozzle row 5L of the recording head 5 as shown in the bottom position of FIG. 3, the light source 8L is turned on and the block region RL of the irradiation region is set to the irradiation state. At the same time, the light source 8R of the light irradiation device 7R is turned off, and the block region RR of the irradiation region is set to the non-irradiation state. Further, when the light irradiation device 7R passes over the row of ink on the recording medium emitted from the nozzle row 5R of the recording head 5, the light source 8R is turned on and the block region RR of the irradiation state is set to the irradiation state. At the same time, the light source 8L of the light irradiation device 7L is turned off, and the block region RL of the irradiation region is set to the non-irradiation state.

The following describes the operation of the ink-jet recording apparatus of the present embodiment.

When the start of recording operation has been instructed, the controller of the ink-jet recording apparatus causes the reciprocating motion of the carriage 4 along the carriage rail 3, similarly to the case of the first embodiment, and causes scanning of the recording head 5 on the recording medium in the main scanning direction Y. At the same time, while checking the scanning position of the recording head 5 based on the scale of the encoder read by the reading apparatus, the controller applies a drive voltage to the nozzles 6L and 6R of the recording head 5 in adequate timing, whereby the photocurable ink is emitted onto the recording medium.

In the case of solid print operation, as shown in FIG. 3, while scanning of the recording head 5 in one direction of the main scanning direction Y, the ink I is emitted from the nozzles 6L and 6R of the nozzle rows 5L and 5R of the recording head 5 in such a way that a row of ink linearly deposited for every other pixel in the sub-scanning direction X on the recording medium will be arranged for every other pixel in the main scanning direction Y.

In the light irradiation devices 7L and 7R corresponding to unit head 5L and 5R, the on and off state of the light sources 8L and 8R is switched on the time-sharing basis in conformity to the alternating current of a predetermined cycle synchronized with the pixel clock shown in FIG. 4 (B).

A row of ink is deposited on the recording medium by the unit head 5L and 5R in the main scanning direction Y at the position displaced from each other by one pixel, and the light irradiation devices 7L and 7R are arranged at positions displaced from each other by an even number of pixels. Accordingly, when the light irradiation device 7L passes above the row of ink on the recording medium emitted from the nozzle row 5L of the recording head 5, the light irradiation device 7R also passes above the row of ink at the other pixel position on the recording medium emitted from the recording head 5L. In this case, the light source 8L of the light irradiation device 7L is turned on and the block region RL of the irradiation region is set to the irradiation state. The ink emitted onto the recording medium is irradiated, and the ink is cured. However, the light source 8R of the light irradiation device 7R is turned off, and the block region RR of the irradiation region is set to the non-irradiation state.

When the light irradiation devices 7L and 7R move to the adjacent pixel positions in the main scanning direction Y, both the light irradiation devices 7L and 7R pass over the row of ink on the recording medium emitted from the nozzle row 5R of the recording head 5. In this case, the light source 8R of the light irradiation device 7R is turned on and the block region RR is set to the irradiation state. Then the ink emitted onto the recording medium is irradiated and cured. However, the light source 8L of the light irradiation device 7L is turned off and the block region RL of the irradiation region is set to the non-irradiation state.

As described above, in the ink-jet recording apparatus of the present embodiment, during the recording operation, the on and off state of the light irradiation devices 7L and 7R is switched on the time-sharing basis, and the two block regions RL and RR of the irradiation region on the recording medium are alternately set to the irradiation state. Accordingly, at least one of the block regions in the irradiation region is set to the non-irradiation state.

As described above, in the present embodiment similarly to the case of the first embodiment, not all the areas of the irradiation region are set to the irradiation state simultaneously, and not all the light sources of the light irradiation device are turned on. This arrangement saves the current consumed in the light irradiation device. Further, the light irradiation device repeats on and off operations and this arrangement reduces the amount of heat generated from the light irradiation device. Thus, the same advantages as those in the first embodiment can be obtained.

The light sources of the light irradiation device are connected in series. This connection reduces the current supplied to the light source and improves the transmission efficiency, as compared to the case of parallel connection. This provides more effective use of the aforementioned advantages. At the same time, the light source of the light irradiation device is connected to provide a circuit shown in FIG. 4 (A) and the alternating current is supplied as shown in FIG. 4 (B). Thus, the on and off state of the light source of the light irradiation device can be switched easily and adequately on the time-sharing basis using a simple circuit. Further, the amount of the wire connection can also be reduced.

### Embodiment 3

The description of the first and second embodiments has referred to the ink-jet recording apparatus wherein ink is simultaneously emitted from the nozzles of the recording head 5 or unit heads 5a and 5b. The following describes the embodiment 3 wherein the recording head 5 is a multi-phase drive type head, and nozzles are divided into a plurality of groups so that ink is separately emitted from the nozzles pertaining to each group.

The following describes the present embodiment wherein the recording head 5 is made of one step and has a single row of nozzles. The present embodiment is also applicable to the case wherein the recording head is composed of rows of nozzles laminated with each other or the unit head is made of multiple steps, as in the case of the aforementioned first and second embodiments. The members having the same functions as those of the aforementioned first embodiment will not be described, or will be described with the same numerals of reference assigned therewith.

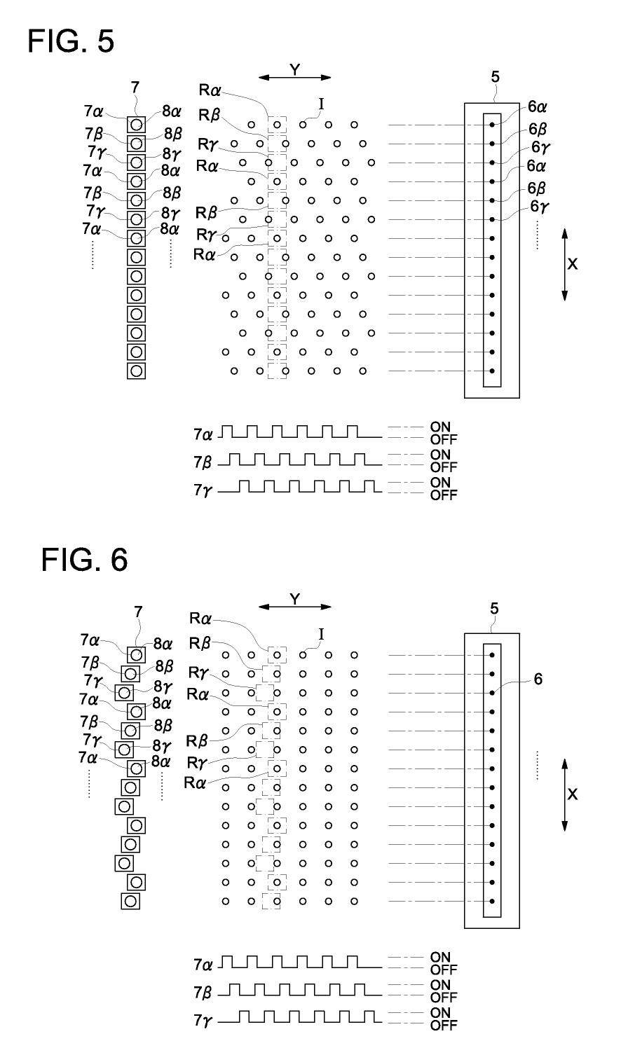

FIG. 1 shows the overall view of the ink-jet recording apparatus of the present invention. The recording head 5 has a single nozzle row, as shown in FIG. 5. This row of nozzles contains nozzles 6α, 6β and 6γ arranged for every other pixel, and each of nozzles 6α, 6β and 6γ forms one group at intervals of two nozzles. Each group is driven for each phase of the three-phase drive.

To be more specific, the ink-jet recording apparatus of the present embodiment is designed in such a way that image recording is completed in six passes. It should be noted, however, that the present invention is not restricted to the 6-pass recording method. It is applicable to all the cases of multi-pass recording. Further, the groups made up of nozzles 6α, 6β and 6γ are referred to as groups α, β and γ respectively.

During the scanning of the recording head 5 in the main scanning direction Y, the nozzles 6α, 6β and 6γ are driven for each phase of the three-phase drive. As shown in FIG. 5, when ink I is emitted from the nozzles 6α, 6β and 6γ, the rows of ink deposited linearly on the recording medium in the sub-scanning direction X at intervals of five pixels are arranged at the adjacent pixel positions in the main scanning direction Y so as to be displaced from each other by two pixels in the sub-scanning direction X.

In the present embodiment, according to the nozzle groups α, β and γ of the recording head 5, one light irradiation device 7 is divided into light irradiation devices 7α, 7β and 7γ. The light irradiation devices 7α, 7β and 7γ are so arranged as to irradiate the ink I emitted onto the recording medium from the nozzles 6α, 6β and 6γ of the recording head 5 respectively.

In the present embodiment, the light irradiation devices 7α, 7β and 7γ irradiate the ink I emitted from each of the nozzles 6α, 6β and 6γ of the recording head 5 respectively. Thus, the light irradiation devices 7α, 7β and 7γ are arranged at approximately the same position as that of the nozzles 6α, 6γ and 6γ respectively in the sub-scanning direction X.

In the present embodiment, the irradiation region on the recording medium irradiated by the light irradiation device 7 is one region as indicated by the broken line in FIG. 5, however is divided according to the light irradiation devices 7α, 7β and 7γ into the block regions Rα, Rβ and Rγ. To be more specific, in the present embodiment, the irradiation region is divided into the block regions Rα, Rβ and Rγ, and control is provided in such a way that the on and off state of the light irradiation devices 7α, 7β and 7γ is switched on the time-sharing basis for each of the block regions Rα, Rβ and Rγ. Thus, the irradiation region is set to the irradiation state or non-irradiation state in units of the divided block regions. The irradiation regions Rα, Rβ and Rγ are moved on the recording medium in the main scanning direction Y by the scanning of the light irradiation devices 7α, 7β and 7γ resulting from the reciprocating motion of the carriage 4 in the main scanning direction Y.

In the light sources 8α, 8β and 8γ of the light irradiation devices 7α, 7β and 7γ of the present embodiment, a plurality of light-emitting diodes constituting the light source are connected in series, similarly to the case of the first embodiment. The on and off state of the light sources 8α, 8β and 8γ of the light irradiation devices 7α, 7β and 7γ is switched on the time-sharing basis with reference to the pixel clock switched according to the three phases synchronized with the 3-phase drive of the recording head, as shown in the bottom position of FIG. 5.

The following describes the operation of the ink-jet recording apparatus in the present embodiment.

Similarly to the case of the first embodiment, when the recording start has been instructed, the controller of the ink-jet recording apparatus causes the reciprocating motion of the carriage 4 along the carriage rail 3, and allows the recording head 5 to scan on the recording medium in the main scanning direction Y. At the same time, while checking the scanning position of the recording head 5 according to the scale of the linear encoder read by the reading apparatus, the controller applies the drive voltage to the nozzles 6α, 6β and 6γ of the recording head 5 for each phase of the three-phase drive in an appropriate emission timing, and allows the photocurable ink to be emitted onto the recording medium.

In the case of solid print operation, as shown in FIG. 5, while scanning of the recording head 5 is performed in one direction of the main scanning direction Y, the ink I is emitted from the nozzles 6α, 6β and 6γ of the recording head 5 in such a way that a row of ink linearly deposited at intervals of five pixels in the sub-scanning direction X on the recording medium is arranged at the adjacent pixel positions in the main scanning direction Y so as to be displaced from each other by two pixels in the sub-scanning direction X.

In the light irradiation devices 7α, 7β and 7γ corresponding to the nozzles 6α, 6β and 6γ of the recording head 5, the on and off state of the light sources 8α, 8β and 8γ is switched on the time-sharing basis with reference to the pixel clock shown on the bottom position.

To be more specific, when the light irradiation device 7α passes above the row of ink on the recording medium emitted from the nozzles 6a of the recording head 5, the light irradiation devices 7β and 7γ also pass above the same row of ink. In this case, light source 8α of the light irradiation device 7α is turned on and the block region Rα is set to the irradiation state. The ink emitted onto the recording medium is irradiated so that the ink is cured. However, the light sources 8β and 8γ of the light irradiation devices 7β and 7γ are turned off and the block regions Rβ and Rγ are set to the non-irradiation state.

When the light irradiation devices 7α, 7β and 7γ are moved to the adjacent pixel positions in the main scanning direction Y by the scanning of the carriage 4, the light irradiation devices 7α, 7β and 7γ pass above the row of ink on the recording medium emitted from the nozzles 6β of the recording head 5. In this case, the light source 8β of the light irradiation device 7β is turned on and the block region Rβ of the irradiation region is set to the irradiation state. The ink emitted onto the recording medium is irradiated so that ink is cured. However, the light sources 8α and 8γ of the light irradiation devices 7α and 7γ are turned off and the block regions Rα and Rγ of the irradiation region are set to the non-irradiation state.

Further, when the light irradiation devices 7α, 7β and 7γ are moved to the adjacent pixel positions in the main scanning direction Y by the scanning of the carriage 4, the light irradiation devices 7α, 7β and 7γ pass above the row of ink on the recording medium emitted from the nozzles 6γ of the recording head 5. In this case, the light source 8γ of the light irradiation device 7γ is turned on and the block region Rγ of the irradiation region is set to the irradiation state. The ink emitted onto the recording medium is irradiated so that ink is cured. However, the light sources 8α and 8β of the light irradiation devices 7α and 7β are turned off and the block regions Rα and Rβ of the irradiation region are set to the non-irradiation state.

As described above, in the ink-jet recording apparatus of the present embodiment during the recording operation, the on and off state of the light irradiation devices 7α, 7β and 7γ is switched on the time-sharing basis, and the block regions Rα, Rβ and Rγ of the irradiation region on the recording medium are sequentially set to the irradiation state. Thus, at least one of the block regions of the irradiation region is set to the non-irradiation state.

As described above, in the present embodiment, similarly to the case of the first and second embodiment, not all the areas of the irradiation region are set to the irradiation state simultaneously, and not all the light sources of the light irradiation device are turned on. This arrangement saves the current consumed in the light irradiation device. Further, the light irradiation device repeats on and off operations. This arrangement reduces the amount of heat generated from the light irradiation device. Thus, the same advantages as those in the first and second embodiment can be obtained.

The nozzles of the recording head are divided into a plurality of groups and the light irradiation device irradiates the block regions of the irradiation region on the recording medium divided into different regions wherein the nozzles of different groups emit photocurable ink. This structure ensures the same advantages as those of the first and second embodiments to be obtained even in the recording head having a single row of nozzles, using the technique of the present embodiment.

As described above, the present embodiment is not restricted to the case wherein the recording head is a multi-phase drive type head. However, the recording head is a multi-phase drive type head, and each group of the recording head is driven for each phase of the multi-phase drive. This structure provides easy implementation of the ink-jet recording apparatus of the present embodiment.

### Embodiment 4

The fourth embodiment is designed in the so-called staggered arrangement wherein each light source of the light irradiation device 7 is arranged so as to be displaced in the main scanning direction Y, as shown in FIG. 6. The following describes the case wherein light sources are grouped, and each group is turned on while being classified for each phase. The groups of the light source are assumed as α, β and γ, similarly to the case of the third embodiment for the following description.

In the present embodiment, nozzles of the recording head 5 or the unit head (not illustrated) can be designed in a straight arrangement, as shown in the drawing, or in a staggered arrangement. FIG. 6 shows the case wherein ink I is emitted from the nozzles 6 of the recording head 5 so as to be arranged in one row on the recording medium in the sub-scanning direction X, without the present embodiment being restricted thereto. Further, in this drawing, for the sake of expediency, ink I is represented as being sparsely deposited on the recording medium. In actual practice, however, ink I is emitted onto each pixel position.

The following describes the present embodiment wherein the recording head 5 is made of one step and has a single row of nozzles. As in the first and second embodiments, the present embodiment is also applicable to the case wherein the recording head is made of the nozzle rows laminated with each other, or the unit head is designed in a multi-step structure. The members having the same functions as those of the aforementioned first embodiment will not be described, or will be described with the same numerals of reference assigned therewith.

In the present embodiment, the overall configuration of the ink-jet recording apparatus is shown in FIG. 1. One light irradiation device 7 is divided into light irradiation devices 7α, 7β and 7γ, and the light sources 8α, 8β and 8γ of the light irradiation devices 7α, 7β and 7γ are displaced in the main scanning direction Y to form a staggered arrangement.

As shown in the on the bottom position of FIG. 6, the light sources 8α, 8β and 8γ of the light irradiation devices 7α, 7β and 7γ are classified for each phase and are turned on for each group with reference to the pixel clock switched by synchronized three phases. The on and off state of the light sources 8α, 8β and 8γ is switched on the time-sharing basis with reference to the pixel clock.

In the present embodiment, as shown in FIG. 6, when the ink I is emitted on the recording medium so as to be arranged in a row, it is not always required that the light irradiation devices 7α, 7β and 7γ should be arranged at the position approximately the same as that of the nozzles 6 of the recording head 5 in the sub-scanning direction X.

In the present embodiment, as shown by the broken line in FIG. 6, the irradiation region on the recording medium irradiated by the light irradiation device 7 is a region isomorphic with the staggered arrangement of the light irradiation device 7, and is divided into block regions Rα, Rβ and Rγ irradiated by the light irradiation devices 7α, 7β and 7γ respectively. To be more specific, in the present embodiment, the irradiation region is divided into the block regions Rα, Rβ and Rγ, and control is provide in such a way that the on and off state of the light irradiation devices 7α, 7β and 7γ is switched on the time-sharing basis with respect to the block regions Rα, Rβ and Rγ. The irradiation region is set to the irradiation state or non-irradiation state for each of the divided block regions.

The irradiation regions Rα, Rβ and Rγ are moved on the recording medium in the main scanning direction Y by the scanning of the light irradiation devices 7α, 7β and 7γ caused by the reciprocating motion of the carriage 4 in the main scanning direction Y. In the present embodiment, similarly to the case of the first embodiment, the light sources 8α, 8β and 8γ of the light irradiation devices 7α, 7β and 7γ are connected with a plurality of light-emitting diodes constituting the light source connected in series.

The following describes the operation of the ink-jet recording apparatus of the present embodiment.

When the start of recording operation has been instructed, the controller of the ink-jet recording apparatus causes the reciprocating motion of the carriage 4 along the carriage rail 3, similarly to the case of the first embodiment, and causes scanning of the recording head 5 on the recording medium in the main scanning direction Y. At the same time, while checking the scanning position of the recording head 5 based on the scale of the encoder read by the reading apparatus, the controller applies a drive voltage to the nozzle 6 of the recording head 5 in adequate timing, whereby the photocurable ink is emitted onto the recording medium.

In the case of solid print operation, as shown in FIG. 6, while scanning of the recording head 5 is performed in one direction of the main scanning direction Y, the ink I is emitted from the nozzle 6 of the recording head 5 in such a way that a row of ink is formed in the sub-scanning direction X on the recording medium.

In the light irradiation devices 7α, 7β and 7γ, the on and off state of the light sources 8α, 8β and 8γ is switched on the time-sharing basis with reference to the pixel clock shown in the bottom position of FIG. 6. To be more specific, when the light irradiation device 7α passes above the ink on the recording medium, the light source 8α is turned on and the block region Rα of the irradiation region is set to the irradiation state. The ink emitted onto the recording medium is irradiated so that ink is cured. In this case, the light sources 8β and 8γ of the light irradiation devices 7β and 7γ are turned off and the block regions Rβ and Rγ of the irradiation region are set to the non-irradiation state.

When the light irradiation device 7β passes above the ink on the recording medium due to the movement of the carriage 4, the light source 8β is turned on with reference to the pixel clock of the next phase of the aforementioned three phases, and the block region Rβ of the irradiation region is set to the irradiation state. The ink emitted onto the recording medium is irradiated so that ink is cured. In this case, the light sources 8α and 8γ of the light irradiation devices 7α and 7γ are turned off and the block regions Rα and Rγ of the irradiation region are set to the non-irradiation state.

Similarly, as the carriage 4 moves further, the ink emitted onto the recording medium is irradiated by the light source 8γ of the light irradiation device 7γ, whereby ink is cured. The light sources 8α and 8β of the light irradiation devices 7α and 7β are turned off and the block regions Rα and Rβ of the irradiation region are set to the non-irradiation state.

As described above, in the ink-jet recording apparatus of the present embodiment, during the recording operation, the on and off state of the light irradiation devices 7α, 7β and 7γ is switched on the time-sharing basis and the block regions Rα, Rβ and Rγ of the irradiation region on the recording medium are sequentially set to the irradiation state. Thus, at least one of the block regions of the irradiation region is set to the non-irradiation state.

As described above, in the present embodiment, similarly to the case of the aforementioned embodiments, not all the areas of the irradiation region are set to the irradiation state simultaneously, and not all the light sources of the light irradiation device are turned on. This arrangement saves the current consumed in the light irradiation device. Further, the light irradiation device repeats on and off operations. This arrangement reduces the amount of heat generated from the light irradiation device. Thus, the same advantages as those in the first and second embodiment can be obtained.

The light sources of the light irradiation device are installed in staggered arrangement, and are turned on for each phase so as to irradiate the block regions of the irradiation region of the recording medium. Thus, the same advantages as those of the aforementioned embodiments can be obtained using the technique of the present embodiment, independently of the nozzle arrangement, namely whether the nozzles of the recording head are installed in a straight arrangement, staggered arrangement or other arrangement.

The recording head 5 and light irradiation device 7 shown with reference to the aforementioned first through fourth embodiments can be designed in any structure if not all the light sources 8 of the light irradiation device 7 emit light simultaneously, and not all the block regions of the irradiation region on the recording medium are irradiated simultaneously. They can be designed in a great number of variations if the light irradiation device 7 irradiates the block region to which ink may be emitted independently of existence of deposited ink, but does not irradiate the block region wherein there is no possibility of ink being emitted thereto for example, the thinned-out pixel position.

1. An ink-jet recording apparatus comprising:
a recording head equipped with a nozzle for emitting photocurable ink to a recording medium; and
a light irradiation device equipped with a light source for irradiating the photocurable ink placed on the recording medium;
wherein the light irradiation device is capable of irradiating each of block regions of an irradiation region on the recording medium, the irradiation region being divided into a plurality of block regions, is capable of selecting between an irradiation state and a non-irradiation state for each of the divided block regions, and switches an on and off state of the light source on a time-sharing basis so that at least one of the plurality of block regions is set to the non-irradiation state during a recording operation.

2. The ink-jet recording apparatus of claim 1,
wherein the light source of the light irradiation device comprises a semiconductor light source.

3. The ink-jet recording apparatus of claim 1,
wherein the switching on the time sharing basis is performed with reference to a pixel clock.

4. The ink-jet recording apparatus of claim 1,
wherein the light irradiation device is configured so that while the block region of the irradiation region passes through a thinned-out pixel position, the non-irradiation state is set for the block region during thinned-out recording.

5. The ink-jet recording apparatus of claim 1,
wherein the light irradiation device is capable of irradiating each of block regions of the irradiation region on the recording medium, the irradiation region being divided into the block regions each of which is equivalent to a recording width of the recording head.

6. The ink-jet recording apparatus of claim 1,
wherein the nozzles of the recording head are divided into a plurality of groups, and the light irradiation device is capable of irradiating each of block regions of the irradiation region on the recording medium, the irradiation region being divided into the block regions on each of which the photocurable ink is emitted from the nozzles of each group of the recording head.

7. The ink-jet recording apparatus of claim 6,
wherein the recording head is a multi-phase drive type head and the each group of the recording head is driven according to each phase of multi-phase drive, and
wherein the switching on the time-sharing basis is performed according to a phase of multi-phase drive.

8. The ink-jet recording apparatus of claim 1,
wherein light sources of the light irradiation device are installed in staggered arrangement, and each light source is turned on separately according to each phase.

9. The ink-jet recording apparatus of claim 1,
wherein the light source of the light irradiation device is configured so that a plurality of light-emitting diodes are connected in series for each light source corresponding to each block region of the irradiation region on the recording medium.

10. The ink-jet recording apparatus of claim 1,
wherein the light source of the light irradiation device is configured to supply an alternating current to a circuit composed of at least two sets of light-emitting diodes in which an anode and a cathode are connected in a reverse direction, and
wherein each block region of the irradiation region on the recording medium is divided for each connecting direction of the light source.
